(19) United States
(12) Patent Application Publication
(10) Pub. No.: US 2026/0073060 A1
(43) Pub. Date: Mar. 12, 2026

(54) SYSTEMS AND METHOD FOR SECURE CRYPTOGRAPHIC OPERATIONS WITHIN A BROWSER ENVIRONMENT USING A NATIVE APPLICATION CONNECTOR

(71) Applicant: Yorktown Systems Group, Inc., Huntsville, AL (US)

(72) Inventor: Jeffrey Lee Schultz, Newport News, VA (US)

(21) Appl. No.: 19/325,802

(22) Filed: Sep. 11, 2025

Related U.S. Application Data
(60) Provisional application No. 63/693,671, filed on Sep. 11, 2024.

(51) Int. Cl. G06F 21/60; G06F 9/445

(52) U.S. Cl. CPC G06F 21/602; G06F 9/44526; G06F 21/604; G06F 2221/2141

(57) ABSTRACT

Disclosed herein are systems and methods for securely performing cryptographic operations, including encryption, signing, validation, verification, and PKI-based identification, within a browser environment by utilizing a native application connector that operates outside the browser's sandbox.

### TECHNICAL FIELD

The present disclosure relates to the field of cryptography and secure digital operations. More specifically, the present disclosure pertains to systems and methods for securely performing cryptographic operations, including encryption, signing, validation, verification, and PKI-based identification, within a browser environment by utilizing a native application connector that operates outside the browser's sandbox.

### BACKGROUND

Historically, web browsers supported native extensions or plugins, such as Java and ActiveX, which allowed full access to the operating system's functionality. These plugins provided full access to OS functionalities and enabled developers to embed advanced features directly into the browser, including the ability to handle cryptographic operations and interact with hardware resources. This allowed legitimate technologies to be developed around browser integration by allowing one to write code, such as Java applets, which would run directly in the browser. One of these technologies was digital signatures whereby a user could open up a PDF directly in the browser to provide direct access to the Windows crypto sub-system or a smart card sub-system. The web application could then talk directly to the sub-system and handle the digital signatures and pass back the information to build the signed PDF. At the same time, however, because browsers were very localized they also became susceptible to cyber attacks, allowing bad actors to inject malicious code and take control of resources, spy on user sessions, steal passwords, to name only a few.

Accordingly, as browsers evolved greater emphasis was placed on security and these capabilities were eliminated. Modem browsers operate in a highly secure, sandboxed environment that restricts access to the operating system, making it challenging for web applications to perform restricted cryptographic operations. Currently, browser extensions are limited to running secure JavaScript, which has the same security restrictions as websites, and there is no intrinsic way of getting outside the browser without designing infrastructure to delegate commands, messaging, permissions, etc. While this shift enhances security by preventing unauthorized access to sensitive data, the deprecation of plugins has created a gap for high-security operations required by various sectors such as the government, the military, and enterprises, which need secure handling of sensitive data.

Accordingly, a need has arisen to meet the growing demand for a secure and efficient solution for managing cryptographic operations, such as document signing, digital signatures, encryption, certificate validation, signature verification, and identification. In both government and military sectors, as well as commercial enterprises, there is a critical need to ensure the integrity, security, and controlled custody of sensitive information throughout its lifecycle.

### SUMMARY

In some aspects, the techniques described herein relate to a system for performing secure cryptographic operations within a browser environment of a user device, the system including: a browser extension configured to securely forward cryptographic requests from a web application to a native cryptographic application via a secure messaging protocol; a native cryptographic application, installed outside of a browser sandbox of the user device, said native cryptographic application having access to an operating system of the user device, wherein the native cryptographic application is configured to perform cryptographic operations using a cryptographic key without exposing the cryptographic key to the browser; and a communication protocol for securely transmitting cryptographic requests and results between the browser extension and the native cryptographic application.

In some aspects, the techniques described herein relate to a system, wherein the secure messaging protocol is selected from the group consisting of Native Messaging, WebSocket API, HTTP Request API, WebRTC or Web Transport.

In some aspects, the techniques described herein relate to a system, wherein communication between the browser extension and the native cryptographic application is secured using methods selected from the group consisting of TLS, ECDH, DH, RSA, or similar applicable algorithms.

In some aspects, the techniques described herein relate to a system, wherein the cryptographic key is stored on a hardware token, a smart card or in a cryptographic store.

In some aspects, the techniques described herein relate to a system, wherein the native cryptographic application is configured to dynamically determine whether to use a local certificate store or a hardware security module (HSM) for the cryptographic operations.

In some aspects, the techniques described herein relate to a system, wherein the native cryptographic application is configured to perform cryptographic operations selected from the group consisting of encryption, signing, certificate validation, and signature verification and identification.

In some aspects, the techniques described herein relate to a system, further including a policy-based access control framework for centrally defining and managing access to the cryptographic operations.

In some aspects, the techniques described herein relate to a system, wherein the policy-based access control framework supports role-based access control (RBAC), allowing different levels of access to the cryptographic operations based on user roles.

In some aspects, the techniques described herein relate to a system, wherein the policy-based access control framework integrates with enterprise group policies for centralized policy management and enforcement.

In some aspects, the techniques described herein relate to a system, wherein the policy-based access control framework incorporates per-site and per-domain access control to restrict cryptographic access to one or more specific websites or domains.

In some aspects, the techniques described herein relate to a system, wherein the per-site and per-domain access control supports wildcard-based domain access rules.

In some aspects, the techniques described herein relate to a system, wherein the policy-based access control framework allows for time and location-based restrictions, permitting access to the cryptographic operations only during specified times or from designated geographic locations.

In some aspects, the techniques described herein relate to a system, wherein the browser extension is configured to periodically send heartbeat messages to the native cryptographic application to maintain communication.

In some aspects, the techniques described herein relate to a system, wherein the native cryptographic application is configured to close a connection or shut down after a period of inactivity.

In some aspects, the techniques described herein relate to a method for securely performing cryptographic operations within a browser environment of a user device, the method including: receiving, by a browser extension, a cryptographic request from a web application; forwarding, by the browser extension, the cryptographic request to a native cryptographic application using a secure messaging protocol, wherein the native cryptographic application is installed outside of a browser sandbox of the user device and has access to an operating system of the user device; performing, by the native cryptographic application, a cryptographic operation using the operating system's cryptographic resources; and returning, by the native cryptographic application through the browser extension, a result of the cryptographic operation to the web application.

In some aspects, the techniques described herein relate to a method, wherein the secure messaging protocol is selected from the group consisting of Native Messaging, WebSocket API, HTTP Request API, WebRTC or Web Transport.

In some aspects, the techniques described herein relate to a method, further including enforcing, by a policy-based access control framework, access rules governing the cryptographic operations based on role, time, location, or other factors.

In some aspects, the techniques described herein relate to a method, wherein performing the cryptographic operation includes encryption using a private key stored on a hardware token, a smart card or in a local certificate store, and wherein the private key is never exposed to the browser.

In some aspects, the techniques described herein relate to a method, wherein location of the private key is dynamically determined by the native application.

In some aspects, the techniques described herein relate to a method, further including periodically transmitting a heartbeat message between the browser extension and the native cryptographic application to maintain active communication.

The technology described herein address this need by providing a system and method for securely delegating cryptographic operations from a browser-based web application to a native cryptographic application installed on the user's device. The browser communicates securely with the native application, which has access to the operating system's cryptographic resources, including hardware tokens, smart cards, and certificate stores.

More particularly, the technology addresses the critical gap noted above by leveraging a messaging-based delegation approach. Instead of executing cryptographic operations directly within the browser, the system securely communicates with a native application installed on the user's machine. This native application connector runs outside the browser's sandbox and has full access to the operating system's cryptographic resources, including hardware tokens, smart cards, and certificate stores. By securely delegating cryptographic tasks to this native application via out-of-process communication methods like Native Messaging, WebSocket API, HTTP Request API, WebRTC or Web Transport, the technology restores the ability to perform complex, high-security tasks within the browser environment without compromising the security model of modem browsers.

This technology was, in one respect, developed to meet the growing demand for a secure and efficient solution for managing cryptographic operations, such as document signing, digital signatures, encryption, certificate validation, signature verification, and identification. In both government and military sectors, as well as commercial enterprises, there is a critical need to ensure the integrity, security, and controlled custody of sensitive information throughout its lifecycle.

Among other benefits which will be apparent from the description to follow, the system is designed to (1) ensure security and integrity during cryptographic operations; (2) simplify cryptographic workflows by integrating functions such as digital signatures, encryption, and PKI-based identification directly into the browser; (3) maintain a chain of custody for resources, ensuring secure handling throughout the signing and approval process without removal from the originating platform; and (4) provide provenance, governance, and auditability, particularly in high-security environments such as government and military operations.

The system uses secure messaging mechanisms such as Native Messaging, WebSocket API, HTTP Request API, WebRTC or Web Transport to communicate between the browser and the native application. This ensures that sensitive cryptographic operations are performed outside the browser's sandbox while maintaining the security of sensitive data.

The system introduces a policy-based access control framework that allows organizations to centrally define and enforce rules governing access to cryptographic operations based on role, location, time, and other factors. This ensures that sensitive operations are tightly controlled in environments such as government, military, finance, and healthcare, where regulatory compliance and security are paramount.

### Overview of the System Architecture

### 1. Browser Extension:

A browser extension 120 acts as the intermediary between the web application 110 and the native cryptographic application. It securely forwards cryptographic requests from the web application 110 to the native application and delivers results back to the web application 110. Communication occurs via secure channels such as Native Messaging (default), WebSocket API, HTTP Request API, WebRTC or Web Transport, depending on the browser's capabilities. The extension ensures that sensitive data is isolated from the browser and web application 110 during cryptographic operations.

### 2. Native Cryptographic Application (Browser Connector):

The native cryptographic application operates outside the browser's sandbox and has full access to the OS's cryptographic resources. It performs cryptographic tasks such as encryption, signing, certificate validation, signature verification, and PKI-based identification using resources like hardware tokens and certificate stores. Moreover, it dynamically determines whether to use a local certificate store or hardware security modules (HSM) for cryptographic operations, ensuring the highest level of security by preventing private keys from being exposed. The native application supports multiple cryptographic algorithms, including AES for encryption and SHA-256 for hashing. In FIPS-compliant environments, only approved algorithms are used.

### 3. Policy-Based Access Control Framework:

Another feature is the policy-based access control framework that allows organizations to define and manage which web application 110s and users can access cryptographic resources through the cryptographic browser connector.
a. Centralized Management: Access control policies can be defined and enforced centrally by administrators, ensuring uniform application of security rules across all users and devices within the organization.
b. Role-Based Access Control (RBAC): Access to cryptographic operations can be granted or restricted based on user roles, such as administrators, approvers, or general users, ensuring that users have access only to the operations necessary for their role.
c. Time and Location-Based Restrictions: Policies can be created to allow access based on time (e.g., only during business hours) or specific locations (e.g., access restricted to a certain geographic region or IP address).

These policies ensure that only authorized users and applications have access to cryptographic functions, maintaining control over sensitive data and reducing the risk of unauthorized operations.

### 4. Per-Site and Per-Domain Access Control:

The system enables administrators to manage which websites or domains can access cryptographic resources.
a. Per-Site Access Control: Administrators can define which individual websites are allowed to perform cryptographic tasks using the browser extension.
b. Wildcard Access for Domains: For broader access control, wildcard rules can be implemented to allow all subdomains under a particular domain to access cryptographic functions (e.g., *.example.com). This feature can be restricted or enabled based on the organization's security policy.

### 5. Group Policy Integration:

The access control framework integrates with enterprise group policies (e.g., Active Directory) for centralized policy management and enforcement. Organizations can use group policies to distribute access rules and ensure consistent application across all devices and users.
a. Policy Distribution and Enforcement: Policies are distributed via group policy tools, automatically applying access rules across an organization's infrastructure.
b. Policy Inheritance: Access control policies can be layered and inherited across different departments, providing flexibility for managing complex organizational structures.

### 6. Security Controls:

The system incorporates robust security measures to ensure the integrity and confidentiality of cryptographic operations:
a. Data Isolation: All cryptographic tasks are performed securely outside the browser sandbox, ensuring that sensitive information like private keys is never exposed to the browser or web application 110s.
b. Audit Logs: All cryptographic operations and access requests are logged, providing a complete audit trail for compliance and security review.
c. Real-Time Policy Enforcement: Access policies are enforced in real-time, dynamically adjusting based on changes to user roles, time, or location. This ensures that any policy changes are immediately reflected in the system.

### 7. Error Handling and Recovery:

The system captures detailed error messages related to cryptographic operations and access control, including issues such as invalid certificates or missing cryptographic keys. Automatic retries and fallback mechanisms are in place for recoverable errors.

### BRIEF DESCRIPTION OF THE DRAWINGS

FIG. 1 is a block diagram of a system for performing secure cryptographic operations within a browser environment.

FIG. 2 is a flowchart of method for securely performing cryptographic operations within a browser environment.

FIG. 3 is a schematic illustration of example internal components and modules of a computing device which may be used to implement one or more aspects of the present disclosure.

### DETAILED DESCRIPTION

Traditional workflows for handling digital signatures and encryption involve cumbersome, multi-step processes in which documents are often passed between different systems or individuals, increasing the risk of data exposure, unauthorized access, or tampering. Accordingly, there is a need to address these drawbacks while also ensuring the provenance, pedigree, and governance of data, especially in environments where strict security and auditability are paramount.

### System Architecture

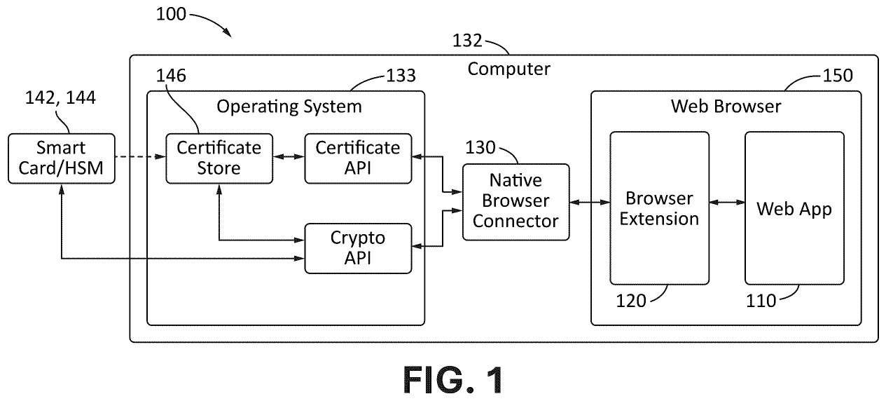

FIG. 1 is a block diagram of a representative system architecture 100, respectively, for implementing at least some of the concepts described herein. A web application 110 communicates with a browser extension 120 which acts as an intermediary to forward cryptographic requests. The browser extension 120 communicates with a native cryptographic application 130, sometimes referred to as a connector, which is installed on the user's machine 132 and operates outside the browser's sandbox. Communication happens via an out-of-process messaging model provided by the browser 150, securely delegating cryptographic operations such as encryption, digital signatures, signature verification, certificate validation, and identification from authorized web application 110s to the native application connector 130.

The web browser extension 120 serves as a secure intermediary between the web application 110 and the native application connector 130. It forwards cryptographic requests (e.g., signing, encryption, certificate validation, identification) from the web application 110 to the native application connector 130 using methods like Native Messaging, WebSocket API, HTTP Request API, WebRTC or Web Transport, depending on the browser's capabilities. The native application connector 130 performs the requested cryptographic tasks using full access to the cryptographic resources of the operating system 133, including hardware tokens, smart cards, and certificate stores.

### Browser Extension

The browser extension 120 acts as a central component in the architecture, managing secure communication between authorized web application(s) 110 and the native application connector 130. The browser extension 120 securely forwards cryptographic requests from web application(s) 110 to the native application connector 130 and ensures secure delivery of the results. The browser extension 120 includes a secure messaging handler configured to forward cryptographic requests between a web application 110 and the native application connector 120. The extension 120 uses different messaging techniques depending on the browser's capabilities, prioritizing secure communication channels in the following order:

Native Messaging (default) is used if supported by the browser 150 for secure, out-of-process communication with the native application connector 130, using ECDH, DH, or RSA for secure key exchange. If Native Messaging is not supported, the extension falls back to WebSocket API for real-time, bi-directional communication protected by TLS. As a last resort, the extension 120 can use HTTP Request API, also secured by TLS, to handle requests and responses between the browser extension 120 and the native application connector 130. This tiered approach ensures secure communication in various environments while maintaining flexibility in handling cryptographic tasks, even in browsers with limited support for certain messaging methods. Sensitive data remains isolated from the browser and web application 110 regardless of the method used.

The browser extension 120 periodically sends heartbeat messages to the native application connector 130 to maintain active communication. If no heartbeat is received, the connector will either shut down or disconnect based on the communication protocol. This ensures resources are conserved and connections are not left open unnecessarily.

An error handling module captures, processes, and communicates cryptographic or communication-related errors back to the web application 110. Together with the secure messaging handler, this ensures secure, reliable communication for cryptographic operations initiated with the browser 150. The browser extension 120 captures and handles errors, sending structured error responses to the web application 110, providing insights into issues like invalid certificates or missing keys.

The browser extension 120 implements a variety of strict security measures. Sandboxing and Permissions ensures only authorized web applications can interact with the extension. User Consent Mechanisms allow user-driven certificate selection through coordination with the native application connector 130 to use the operating system's native dialogs, and data Isolation ensures cryptographic operations occur within secure environments, like hardware tokens or the native application connector 130. The browser extension 120 also supports future cryptographic functions and can be updated securely through the browser's standard update mechanism or using more traditional software distribution channels managed by the organization.

The native application connector 130 is a system component that preferably operates as a native application outside the browser 150. It interfaces between the browser extension 120 and the operating system's cryptographic resources, allowing for direct interaction with smart cards 142, hardware security modules (HSMs) 144, and certificate stores 146. This design ensures that sensitive cryptographic operations, such as encryption, signing, certificate validation, and identification, are securely handled by the native application outside the browser's sandbox, maintaining the integrity and security of sensitive data. By running independently from the browser 150, the connector can leverage full operating system capabilities while ensuring that no sensitive data or cryptographic keys are exposed to the browser environment.

The native application connector 130 allows web applications to specify the desired cryptographic algorithms for encryption, hashing, and signatures. Web applications can request algorithms like AES for encryption or SHA-256 for hashing, while the operating system determines which algorithms are available based on its security settings. For example, in environments where FIPS (Federal Information Processing Standards) compliance is enforced, only FIPS-approved algorithms will be made available. If a web application requests an algorithm not supported by the current configuration, the native application connector 130 will return an appropriate error message and may suggest alternatives based on the system's configuration.

### Role of the Native Application Connector

The native application connector 130 manages and executes cryptographic tasks (encryption, signing, validation, identification) by leveraging the operating system's cryptographic APIs and hardware resources. It ensures sensitive data, like private keys, are never exposed to the browser 150 or web application 110. The connector dynamically determines whether to use a local certificate from the system certificate store or an HSM based on the certificate's availability and configuration. When an HSM is detected and associated with the requested certificate, the cryptographic operation is offloaded to the hardware, ensuring that the private key remains secure and never leaves the HSM. The connector 130 interacts with cryptographic resources and has full access to:

Hardware Tokens: Secure hardware devices like smart cards and USB tokens (e.g., PKI smart cards or HSMs) accessed via secure OS-provided APIs.

Certificate Stores: Both system and application-level certificate stores for retrieving and validating certificates. The connector intelligently selects either the local certificate store or HSM based on certificate configuration.

Operating System Cryptographic APIs: APIs (e.g., Windows CryptoAPI, macOS Security framework, or Linux crypto libraries) used for secure operations. The native application connector 130 is also responsible for delegating cryptographic tasks. For example, once the browser extension 120 forwards a request, the native application connector 130 delegates the task to the appropriate handler:

Encryption: The native application connector 130 uses the private key from either a hardware token (HSM) or a local certificate store for encryption, ensuring the key is never exposed. The connector automatically selects the appropriate resource based on the certificate configuration.

Digital Signing: The connector 130 signs data using a private key stored within either a secure hardware device or the local certificate store. The system intelligently determines which resource to use based on the location of the certificate.

Certificate Information Retrieval: The connector 130 retrieves and returns structured certificate data, such as issuer, subject, and validity, from either the local store or HSM.

Certificate Validation and Signature Verification: The connector 130 ensures certificates are authentic and digital signatures are valid, regardless of whether the certificate resides locally or in an HSM.

When a web application submits a cryptographic request, it can also specify which encryption and hashing algorithms to use. The native application connector 130 validates the availability of the requested algorithms based on the operating system's cryptographic configuration. For instance, if the application requests AES-256 encryption or SHA-256 hashing, the connector 130 ensures the system supports these algorithms before proceeding. In FIPS-enabled environments, the system may limit algorithm options to FIPS-compliant versions, returning an error or alternative suggestion if the requested algorithms are unavailable.

With respect to message exchange and validation, all communications between the web application 110, browser extension, and native application connector 130 are carried out using structured messages to ensure secure and reliable data transmission. Each message contains a length integer, which is the first part of each message is an integer that specifies the total size of the message, ensuring that the entire message can be properly parsed. The second part of the message is an encoded data structure. This structured data contains fields for cryptographic operations. Each field in the data structure is validated based on length and data type. Messages are validated through the following validation process:

Length Validation: The system checks that the length integer matches the actual size of the message. If the lengths do not match, the message is rejected.

Field Validation: Each field within the encoded data structure is checked to ensure it adheres to the expected length and data type (e.g., strings, integers, cryptographic keys, or certificates). If any field is invalid, the message is rejected. If validation fails at any point, the request is closed, and the client must reinitiate the request. All message exchange activities, including validation failures, are logged into the operating system's logging subsystem for auditing and troubleshooting purposes.

The native application connector 130 also uses a heartbeat mechanism to maintain communication with the browser extension 120. This periodic message allows the native application connector 130 to confirm that the browser extension 120 is still connected and operational. If no heartbeat message is received within a designated period, or if no activity occurs for more than a minute, the native application connector 130 shuts down or disconnects, depending on the communication protocol used. For example, when native messaging is employed, if the heartbeat message is absent for over a minute (with secure communication managed using ECDH, DH, or RSA depending on browser support), or there is no activity, the native application connector 130 automatically shuts down to conserve system resources. This mechanism ensures efficient resource management and enhances security by closing idle connections that could otherwise pose a risk.

If, however, WebSocket API or HTTP Request API protocols are employed, the native application connector 130 will terminate the connection after one minute of inactivity or if no heartbeat message is received, disconnecting gracefully from the browser extension.

Once the native application connector 130 identifies the specific cryptographic operation (e.g., encryption, signing, validation, verification, identification), it dispatches the request to the appropriate handler. Each handler manages a specific cryptographic function:

An encryption handler manages data encryption using a private key via the cryptographic API or securely within an HSM (smart card or USB token). The private key is never directly retrieved or exposed. The system intelligently determines whether to use a local certificate or HSM for encryption based on the certificate configuration. If no certificate identifier is provided, the operating system prompts the user with a certificate selection dialog.

A signature handler handles digital signing requests using a private key stored in either a local certificate store or an HSM. The system automatically detects the location of the private key and performs the signing operation without exposing the key. If no certificate identifier is supplied, the user is prompted to select a certificate via a native OS dialog.

An identification handler retrieves detailed information about a certificate, including issuer, subject, validity, and trust chain. If no certificate identifier is provided, the system prompts the user to manually select a certificate from available local certificates or HSM-based certificates.

A certificate validation and signature verification handler verifies the authenticity and trustworthiness of certificates and validates digital signatures, ensuring that the signature was created using a trusted certificate and private key, regardless of whether the certificate resides locally or in an HSM. It ensures that the data hasn't been altered. After performing the cryptographic operation, the result is sent back to the browser extension, which forwards the result to the web application 110, ensuring the correct request is handled using unique request identifiers.

With respect to secure isolation and operation, private keys are never exposed to the browser or web application 110. All operations requiring private keys are performed securely within hardware or through cryptographic APIs. Cryptographic operations also occur in an isolated process, preventing unauthorized access to sensitive data. For certain operations, user authentication is preferably required. For example, the user must enter a PIN before accessing the private key for cryptographic operations when using an HSM.

Certificate Selection Dialog: If no certificate identifier is provided, the system prompts the user to manually select the certificate, either from the local store or from connected HSMs.

### Error Handling and Recovery

Detailed Error Reporting: In case of errors (e.g., missing hardware token, invalid certificate), the connector provides detailed error messages for diagnosis.

Automatic Retry Mechanisms: For temporary issues (e.g., hardware unavailability), the connector automatically retries the operation.

Fallback Handling: If hardware resources are unavailable, the connector can fallback to alternate methods like software-based key storage, if configured.

### Security and Compliance

The connector meets stringent security and compliance requirements:

FIPS 140-2 Compliance: Ensures cryptographic operations conform to security standards when interacting with FIPS-compliant hardware.

Tamper Detection: Built-in tamper detection prevents unauthorized access or modification of the cryptographic environment.

Audit and Logging: All operations, including message validation failures and cryptographic activity, are securely logged in the operating system's logging subsystem, providing a detailed audit trail for compliance purposes while ensuring sensitive data, such as private keys, are not exposed in the logs.

### Extensibility and Platform Support

The native application connector supports major platforms (Windows, macOS, Linux) and can be extended to support new cryptographic devices and standards.

### Website Restrictions and Access Control

To ensure that only authorized web applications can interact with the native application connector, a robust access control mechanism is implemented. This system mitigates potential security risks, such as unauthorized access to sensitive cryptographic operations, malicious websites attempting to exploit the system, or untrusted applications gaining access to encryption keys and certificates. The access control framework restricts interactions to trusted websites, either individually or through broader rules, providing fine-grained control over which web applications are permitted to use the software. These controls are essential for protecting sensitive data and maintaining system integrity in environments where cryptographic operations are critical. Without such controls, the native application connector would be exposed to several security risks, including:

Unauthorized Access: Without limiting access to specific, trusted web applications, unauthorized or malicious sites could potentially interact with the native application connector, leading to improper use of sensitive cryptographic operations.

Data Leakage: If unrestricted, sensitive operations such as digital signing, encryption, certificate validation, or identification, could be initiated by untrusted or malicious websites, potentially leading to the exposure of sensitive data.

Man-in-the-Middle Attacks: Malicious websites could attempt to intercept communications between the browser extension and the native application connector native application connector 130, gaining unauthorized access to certificates, private keys, or cryptographic operations.

Exploitation of Vulnerabilities: Without proper access control, vulnerabilities in less secure websites or web applications could be exploited to attack the cryptographic system, compromising the security of critical cryptographic resources.

To mitigate these risks, a variety of access control measures can be implemented. For example, access to the native application connector 130 can be granted on a per-website basis, ensuring that only explicitly approved websites can interact with the connector. Each website must be registered and authorized before being granted access to the native application connector 130, ensuring that cryptographic operations are only performed for trusted web applications. This helps mitigate the risk of unauthorized or malicious websites exploiting cryptographic resources.

In cases where broader access is needed, the native application connector native application connector 130 supports wildcard-based access control. This allows multiple websites within a domain (e.g., *.company.com) to be granted access at once. While this approach provides flexibility and simplifies management, it also introduces potential risks, such as inadvertently allowing access to less secure subdomains. To mitigate these risks, wildcard-based access should be used cautiously and only when necessary, with careful consideration of the domain's security posture.

The native application connector 130 maintains an internal database of approved websites that are authorized to use the software. This database ensures that only websites listed in the system are permitted to communicate with the native application connector 130 and perform cryptographic operations. By maintaining this database, the system can prevent unauthorized websites from initiating potentially harmful or unapproved operations. This database can be managed by local administrators or enforced through organizational group policies, ensuring that access to cryptographic resources is tightly controlled and monitored. In addition to the security benefits, these access controls help organizations comply with regulatory and security standards that require strict control over cryptographic operations, such as PCI-DSS, HIPAA, or FIPS 140-2. Ensuring that only trusted websites can access sensitive cryptographic resources prevents accidental misuse or exploitation, safeguarding both the system and its users from a wide range of security threats.

For website management, a list of approved websites can be managed in several ways. Local administrators can manually approve, add, or remove websites from the approved list through a local configuration interface. This provides flexibility for smaller environments or single-user scenarios. In enterprise environments, website access control can be centrally managed using group policies. Administrators can define which websites are allowed to use the native application connector 130 across an entire organization, ensuring uniform security policies across all users. Websites can also initiate the registration process by providing a manifest file. This file, hosted by the web application 110, contains information required for registration and can be downloaded to begin the app registration process. Administrators can review and approve these manifest-based registrations as needed. All features of the access control system, including manual website management and manifest-based registrations, can be locked down according to group policies. This allows organizations to enforce strict security policies, enabling or disabling specific features, such as manual site registration or wildcard access, or providing policy overrides that define approved websites across the organization. These access control features ensure that only authorized and trusted web application 110s can interact with the native application connector 130, preventing unauthorized use of cryptographic resources while allowing organizations to tailor the software to their security needs.

The following describes the detailed handler flow for the system:

### Encryption Handler Flow:

Step 1: The web application 110 sends an encryption request to the browser extension.
Step 2: If no certificate identifier is provided, the connector triggers a certificate selection dialog.
Step 3: The extension forwards the request to the connector, which performs encryption using the appropriate resource (local certificate or HSM).
Step 4: The encrypted data is returned to the browser extension.
Step 5: The browser extension 120 transmits the encrypted data to the web application 110.

### Signature Handler Flow:

Step 1: The web application 110 sends a signing request to the browser extension.
Step 2: If no certificate identifier is provided, the user selects a certificate via the OS dialog.
Step 3: The request is forwarded to the connector, which performs the signing using the appropriate resource (local certificate or HSM).
Step 4: The signature is returned to the browser extension.
Step 5: The signature is sent to the web application 110.

### Identification Handler Flow:

Step 1: The web application 110 requests certificate details.
Step 2: If needed, the connector prompts the user to select a certificate.
Step 3: The connector retrieves and formats the certificate details from the appropriate store (local or HSM).
Step 4: The information is sent to the web application 110 via the browser extension.

### Certificate Validation and Signature Verification Handler Flow:

Step 1: The web application 110 requests validation or signature verification.
Step 2: The extension forwards the request to the connector.
Step 3: The connector validates the certificate or verifies the signature, whether stored locally or in an HSM.
Step 4: The result is returned to the web application 110 via the browser extension.

### Software Delivery and Installation

The system is designed to be delivered in multiple ways, providing flexibility in deployment based on customer needs and preferences. The browser extension 120 and native application connector 130 are distinct components and can be installed separately or bundled together, depending on the deployment method chosen.

For example, the browser extension 120 can be delivered and installed via standard browser extension 120 stores (e.g., Chrome Web Store, Firefox Add-ons, Microsoft Edge Add-ons). Users can download and install the browser extension 120 directly from these stores. However, the native application connector 130 is a native application and cannot be delivered through the browser extension 120 store because it operates outside the browser sandbox and requires direct access to the operating system's cryptographic resources.

If the browser extension 120 is installed via the extension store, the native application connector 130 must be installed separately via a dedicated installer, which can be provided through a company or customer portal, or distributed via traditional software deployment tools. Once installed, the browser extension 120 will communicate with the native application connector 130.

The browser extension 120 and native application connector 130 can also be bundled together in a single package for installation. This approach allows both components to be installed at the same time, ensuring that they are fully integrated and ready to work together upon installation. This bundled installation package can be delivered to the user in several ways. For example, users can download the bundled installer directly from a secure customer or company portal. For enterprise environments, the bundled package can be remotely deployed using remote administration tools (e.g., Microsoft SCCM, JAMF, or other enterprise software deployment tools), allowing for seamless installation across multiple machines without user intervention. This flexible delivery model allows customers to choose the most appropriate method for their environment, ensuring a smooth deployment process whether it's for individual users or an enterprise-wide deployment.

### Security and Communication Flow

The native application connector 130 securely performs tasks such as encryption, signing, certificate validation, and identification, using operating system resources like hardware tokens and smart cards. All cryptographic operations are performed in a secure environment, ensuring private keys never leave secure hardware or certificate stores. Only authorized web applications are allowed to interact with the connector, preventing unauthorized access. The system determines whether a local certificate or HSM is used based on the certificate's configuration and availability. If an HSM is available and associated with the certificate, the operation is offloaded to the HSM to ensure the highest level of security.

Communication between the browser extension 120, web application 110, and native application connector 130 is divided into manageable chunks, ensuring security and integrity even when processing large requests (e.g., signing or encrypting large files). The heartbeat mechanism ensures the native application connector 130 shuts down or disconnects after a minute of inactivity or if the heartbeat message is not received. Secure communication is managed using TLS for WebSocket API and HTTP Request API, or ECDH, DH, or RSA for Native Messaging, ensuring the highest level of security. All activities, including message validation, are securely logged to the operating system's logging subsystem for auditing and security purposes.

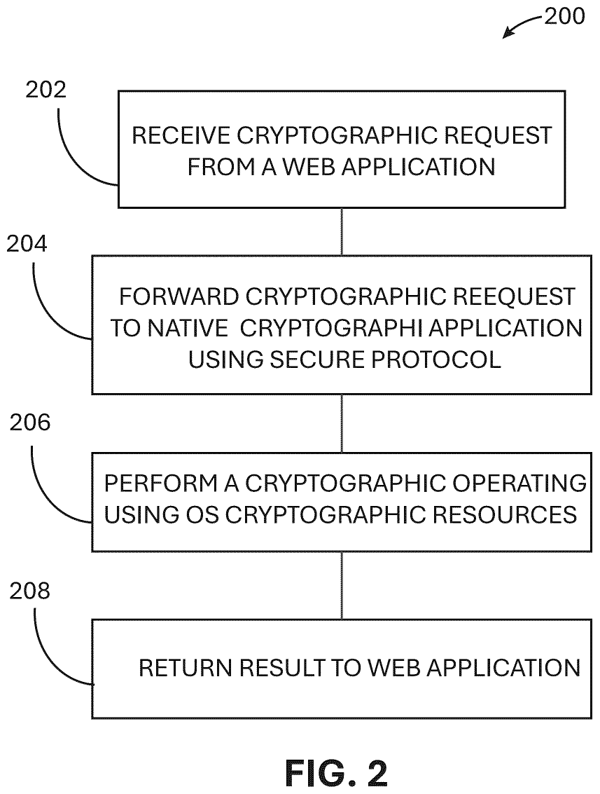

FIG. 2 illustrates method 200 for securely performing cryptographic operations within a browser environment of a user device. A cryptographic signing or validation request is transmitted from a web application to the browser extension 202. The request is parsed and securely forwarded by the browser extension to the native application connector at 204. At 206, the native application connector performs a cryptographic operation using the operating systems cryptographic resources. Results are then returned to the browser extension, through the native application connector, and securely communicated back to the originating web application at 208.

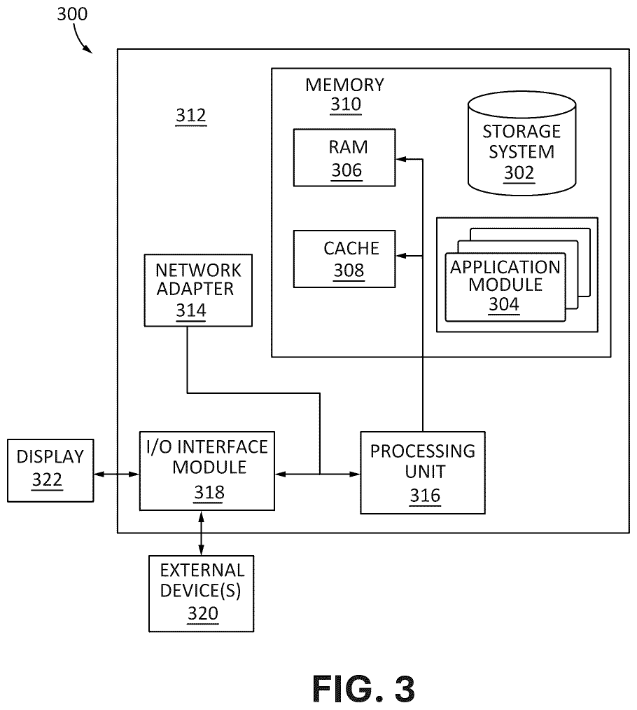

FIG. 3 is a schematic illustration of example internal components and modules of a computing device for implementing one or more components according to the present disclosure. In one aspect, as illustrated in FIG. 3, the computing device 300 is a special purpose mobile computing device illustrated as having physical components and software or modules operating on those physical components (e.g., “components” altogether).

In particular, in another aspect, as illustrated in FIG. 3, a computing system 312 of the computing device 300 includes several components. The computing system 312 contains a storage system 302 comprised of solid-state drive technology. The storage system 302 also is equipped with any other technologies for the storage of computing information.

In another aspect, as illustrated in FIG. 3, a computing system 312 of the computing device 300 includes application(s), instruction(s), and data that are available to the components. In particular, the application(s), instruction(s), and data reside short term or long term on the storage system 302. The memory 310 of the computing system 312 also includes random access memory (RAM) 306 which can hold the program instructions along with a cache 308 for buffering the flow of instruction/data to the processing unit 316, for example. As such, the memory 310 comprises computer storage media and communication media, and includes both volatile and non-volatile media and removable and non-removable media.

By way of example, in another aspect, the memory 310 includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store a desired information for access by a processor(s) or processing unit(s). The memory 310 also includes computer-readable instructions, data structures, program modules or other data in a modulated data signal, such as a carrier wave or other transport mechanism, and includes any information delivery media. A modulated data signal refers to a signal that has one or more of its characteristics set or changed in such a manner as to encode information in the signal. Furthermore, the memory 310 includes or involved wired media such as a wired network or direct-wired connection, and wireless network or wireless connections, and node-to-node or peer to peer (P2P) network or P2P connections. Combinations of any of the above are included within the scope of the present disclosure.

Returning generally to FIG. 3, in another aspect, the executed application module(s) 304 reside in the RAM 306 as instructions executed by the processor(s) or processing unit(s) 316. As such, the processing unit(s) 316 is communicatively coupled through a bus to a network adapter 314 that facilitates communications, for example. The processing unit 316 also is communicatively coupled through a bus to an input/output interface module (IO) 318 that is connected to a display 322, which displays a graphical user interface (GUI), for example, and to other external peripheral input/output devices or components, for example. The IO module 318 also is configured to interface with other external devices 320 such as a universal serial bus adapter, lightning port, power port, and/or a whole host of other IO devices that are traditionally found interfacing with a general-purpose and/or a special purpose device as described herein.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Physical and functional components (e.g., devices, engines, modules, and data repositories, etc.) associated with processing device can be implemented as circuitry, firmware, software, other executable instructions, or any combination thereof. For example, the functional components can be implemented in the form of special-purpose circuitry, in the form of one or more appropriately programmed processors, a single board chip, a field programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip (e.g., software, software libraries, application program interfaces, etc.). The tangible storage memory can be computer readable data storage. The tangible storage memory may be volatile or non-volatile memory. In some embodiments, the volatile memory may be considered “non-transitory” in the sense that it is not a transitory signal. Memory space and storages described can be implemented with the tangible storage memory as well, including volatile or non-volatile memory.

Note that any and all of the embodiments described above can be combined with each other, except to the extent that it may be stated otherwise above or to the extent that any such embodiments might be mutually exclusive in function and/or structure.

With the foregoing description in mind, various advantages can be realized from the teachings herein. As noted above, the technology solves key issues in cryptographic workflows by:
1. Ensuring Security and Integrity
The native application connector 130 eliminates the need to move sensitive data across insecure systems or rely on external tools for signing and encryption. By embedding the cryptographic functionality directly into the browser and securely managing it via a native application, sensitive operations such as signing or encryption remain within a secure, isolated environment, protecting the data throughout its lifecycle.
2. Simplifying Cryptographic Operations
The technology reduces complexity for users by handling cryptographic operations like digital signatures, encryption, and validation directly within the browser. This is particularly beneficial for large organizations where multiple layers of approval or document custody are required.
3. Maintaining Chain of Custody
In certain environments, maintaining control over the chain of custody for sensitive documents is essential. The system's ability to control and restrict access to specific websites ensures that only authorized applications can interact with cryptographic resources. This tight control over the signing and encryption process means that documents are securely handled at every stage of their approval workflow, preventing unauthorized manipulation or tampering.
4. Provenance, Governance, and Pedigree With native encryption, signature, and PKI functions available directly in the browser, the web application 110 can directly validate against the PKI infrastructure. This enables full verification of document history, authenticity, and compliance with regulatory requirements, all while maintaining the highest levels of security.

Specific benefits are provided in the following use cases:

### 1. Government and Military

Government and military sectors require the highest levels of security when handling sensitive data, particularly when documents require multiple layers of approval or secure exchange between individuals or departments. The technology developed solves several critical needs for these sectors:

### Controlled Custody in Signing and Approval Workflows

Military and government organizations must maintain strict control over documents from creation to final approval. The native application connector 130 ensures that only authorized parties can access, sign, or modify these documents, while the document itself remains securely on the web application 110's platform. By leveraging in-browser editing and digital signature capabilities, documents do not need to be downloaded to the end-user's machine for signing or approval. This ensures that sensitive data never leaves the secure environment of the web application 110, maintaining complete custody and preventing unauthorized access or tampering during the signing process. By integrating hardware security modules (HSMs) and local certificate stores, the technology ensures that sensitive cryptographic operations are always performed in secure environments, and no unauthorized access to cryptographic keys or certificates occurs.

### Enhanced Governance and Compliance

With built-in audit logs, the technology ensures full traceability of every cryptographic operation, enabling government and military organizations to comply with strict regulatory standards such as FIPS 140-2, PCI-DSS, or HIPAA. Every action taken on a document is logged, providing a comprehensive audit trail for security compliance.

### Provenance and Pedigree

The native application connector 130 strengthens the provenance and pedigree of documents by enabling direct access to PKI cryptographic operations. This access allows government and military organizations to validate the authenticity and integrity of documents in real-time by leveraging PKI infrastructure directly within the browser. By utilizing native PKI encryption, digital signatures, and certificate validation, documents retain an immutable chain of trust that verifies who signed or modified the document, when it was altered, and under what authority. This capability is critical for both legal and operational needs, where proving a document's history, authenticity, and compliance with strict security requirements is crucial for accountability, legal validation, and maintaining operational integrity.

### 2. Commercial Sector Applications

The technology also has broad applicability in the commercial sector. Many industries, such as finance, healthcare, and legal, require secure, auditable document workflows to maintain compliance with industry standards and protect sensitive client or customer information. The native application connector 130 offers a powerful solution for:

### Finance

Financial institutions handle large volumes of contracts, approvals, and transactions that require secure digital signatures and encryption. This technology ensures that these documents are securely signed, encrypted, and stored, maintaining the integrity and traceability of financial records.

### Healthcare

In healthcare, securing patient data is paramount. The native application connector 130 can be used to protect sensitive health records by ensuring only authorized personnel can access, modify, or sign medical documents. This approach supports compliance with standards such as HIPAA, ensuring that healthcare organizations maintain strict control over patient information.

### Legal

Law firms and legal departments rely on document integrity for contracts, case files, and legal documents. This technology provides a secure method for digitally signing and encrypting legal documents, ensuring that no unauthorized changes can be made and providing a complete audit trail for legal validation.

In addition to its specialized use cases in government, military, and commercial sectors, this technology offers at least the following broader benefits:

1. Compliance with Industry Standards

The system's ability to enforce strict access controls, manage cryptographic keys securely, and provide comprehensive logging helps organizations meet a variety of industry-specific compliance requirements.

### 2. Ease of Integration

With flexible deployment options, the native application connector 130 can be easily integrated into existing enterprise workflows, either as a standalone solution or bundled with other security tools.

### 3. Scalability

The technology is designed to scale across large organizations, allowing for centralized management of cryptographic operations, whether it's in a government agency or a multinational corporation. By providing a secure, auditable solution for managing cryptographic workflows, this technology addresses key challenges faced by organizations in both the public and private sectors, ensuring that sensitive data is protected while maintaining compliance with regulatory standards.

Also with the foregoing in mind, the technology can be characterized as a system for performing secure cryptographic operations within a browser environment. Such a system may comprising (1) a browser extension 120 configured to securely forward cryptographic requests from a web application 110 to a native cryptographic application via secure messaging protocols; (2) a native cryptographic application, installed outside the browser's sandbox, having access to the operating system's cryptographic resources, including hardware tokens, smart cards, and certificate stores; (3) a communication protocol selected from the group consisting of Native Messaging, WebSocket API, HTTP Request API, WebRTC or Web Transport, for securely transmitting cryptographic requests and results between the browser extension 120 and the native cryptographic application; and (4) a policy-based access control framework enabling organizations to centrally define and manage access to cryptographic operations based on roles, time, location, and other factors.

In some embodiments, the policy-based access control framework supports centralized management of access rules, allowing administrators to define and enforce access policies across an organization.

In some embodiments, the policy-based access control framework supports role-based access control (RBAC), allowing different levels of access to cryptographic operations based on user roles.

In some embodiments, the policy-based access control framework allows for time and location-based restrictions, permitting access to cryptographic operations only during specified times or from designated geographic locations.

In some embodiments, per-site and per-domain access control allow administrators to restrict cryptographic access to specific websites or domains, including wildcard-based domain access rules.

In some embodiments, group policy integration allows organizations to centrally manage and distribute access control policies across all users and devices within the organization.

In some embodiments, real-time enforcement of access control policies ensures that any updates or changes to policies are immediately reflected across all users and devices.

In some embodiments detailed audit logging for all cryptographic operations, access requests, and policy changes, provide a comprehensive audit trail for compliance and security purposes.

In some embodiments, the native cryptographic application performs cryptographic operations, including encryption, signing, certificate validation, and signature verification, using hardware tokens or local certificate stores, ensuring that sensitive data such as private keys is never exposed to the browser.

In some embodiments, communication between the browser extension 120 and the native cryptographic application is secured using methods selected from the group consisting of TLS, ECDH, DH, RSA, or similar applicable algorithms, ensuring secure transmission of cryptographic requests and results.

In some embodiments, cryptographic authentication is performed using PKI-based identification, leveraging X.509 certificates for secure mutual authentication with web application 110s directly within the browser sandbox and the cryptographic infrastructure.

In some embodiments, the native application supports secure authentication mechanisms such as digital signatures, ensuring that only authorized users can perform cryptographic tasks like signing, encryption, validation, verification, and identification. Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

What is claimed is:

1. A system for performing secure cryptographic operations within a browser environment of a user device, the system comprising:
a browser extension configured to securely forward cryptographic requests from a web application to a native cryptographic application via a secure messaging protocol;
a native cryptographic application, installed outside of a browser sandbox of the user device, said native cryptographic application having access to an operating system of the user device, wherein the native cryptographic application is configured to perform cryptographic operations using a cryptographic key without exposing the cryptographic key to the browser; and
a communication protocol for securely transmitting cryptographic requests and results between the browser extension and the native cryptographic application.

2. The system of claim 1, wherein the secure messaging protocol is selected from the group consisting of Native Messaging, WebSocket API, HTTP Request API, WebRTC or Web Transport.

3. The system of claim 1, wherein communication between the browser extension and the native cryptographic application is secured using methods selected from the group consisting of TLS, ECDH, DH, RSA, or similar applicable algorithms.

4. The system of claim 1, wherein the cryptographic key is stored on a hardware token, a smart card or in a cryptographic store.

5. The system of claim 1, wherein the native cryptographic application is configured to dynamically determine whether to use a local certificate store or a hardware security module (HSM) for the cryptographic operations.

6. The system of claim 1, wherein the native cryptographic application is configured to perform cryptographic operations selected from the group consisting of encryption, signing, certificate validation, and signature verification and identification.

7. The system of claim 1, further comprising a policy-based access control framework for centrally defining and managing access to the cryptographic operations.

8. The system of claim 7, wherein the policy-based access control framework supports role-based access control (RBAC), allowing different levels of access to the cryptographic operations based on user roles.

9. The system of claim 7, wherein the policy-based access control framework integrates with enterprise group policies for centralized policy management and enforcement.

10. The system of claim 7, wherein the policy-based access control framework incorporates per-site and per-domain access control to restrict cryptographic access to one or more specific websites or domains.

11. The system of claim 10, wherein the per-site and per-domain access control supports wildcard-based domain access rules.

12. The system of claim 7, wherein the policy-based access control framework allows for time and location-based restrictions, permitting access to the cryptographic operations only during specified times or from designated geographic locations.

13. The system of claim 1, wherein the browser extension is configured to periodically send heartbeat messages to the native cryptographic application to maintain communication.

14. The system of claim 1, wherein the native cryptographic application is configured to close a connection or shut down after a period of inactivity.

15. A method for securely performing cryptographic operations within a browser environment of a user device, the method comprising:
receiving, by a browser extension, a cryptographic request from a web application;
forwarding, by the browser extension, the cryptographic request to a native cryptographic application using a secure messaging protocol, wherein the native cryptographic application is installed outside of a browser sandbox of the user device and has access to an operating system of the user device;
performing, by the native cryptographic application, a cryptographic operation using the operating system's cryptographic resources; and
returning, by the native cryptographic application through the browser extension, a result of the cryptographic operation to the web application.

16. The method of claim 15, wherein the secure messaging protocol is selected from the group consisting of Native Messaging, WebSocket API, HTTP Request API, WebRTC or Web Transport.

17. The method of claim 15, further comprising enforcing, by a policy-based access control framework, access rules governing the cryptographic operations based on role, time, location, or other factors.

18. The method of claim 15, wherein performing the cryptographic operation comprises encryption using a private key stored on a hardware token, a smart card or in a local certificate store, and wherein the private key is never exposed to the browser.

19. The method of claim 18, wherein location of the private key is dynamically determined by the native application.

20. The method of claim 15, further comprising periodically transmitting a heartbeat message between the browser extension and the native cryptographic application to maintain active communication.
